(19) United States
(12) Patent Application Publication
(10) Pub. No.: US 2006/0045718 A1
(43) Pub. Date: Mar. 2, 2006

(54) Hub assembly for robotic arm having pin spacers

(75) Inventor: Richard J. Kent, Newbury, NH (US)

Correspondence Address: FORTKORT GRETHER + KELTON LLP, 9442 N. Capital of Texas Hwy., Suite 500, AUSTIN, TX, 78759, US

(73) Assignee: Fabworx Solutions, Inc.

(21) Appl. No.: 11/102,104

(22) Filed: Apr. 8, 2005

Related U.S. Application Data
(60) Provisional application No. 60/560,798, filed on Apr. 8, 2004.
(60) Provisional application No. 60/560,406, filed on Apr. 8, 2004.

(51) Int. Cl. B66C 23/00

(52) U.S. Cl. 414/744.5

(57) ABSTRACT

A robotic hub assembly is provided which comprises a spacer configuration (101) that includes first (103) and second (105) spacers disposed in opposing relation to each other, and a device, such as a pin (111), for restricting the relative motion of the first and second spacers in a lateral direction.

### TECHNICAL FIELD OF THE INVENTION

The present invention pertains generally to wafer processing equipment, and more particularly, to end effectors for such equipment.

### BACKGROUND OF THE INVENTION

Modem semiconductor processing systems include cluster tools that integrate a number of process chambers together in order to perform several sequential processing steps without removing the substrate from the highly controlled processing environment. These chambers may include, for example, degas chambers, substrate pre-conditioning chambers, cooldown chambers, transfer chambers, chemical vapor deposition chambers, physical vapor deposition chambers, and etch chambers. The combination of chambers in a cluster tool, as well as the operating conditions and parameters under which those chambers are run, are selected to fabricate specific structures using a specific process recipe and process flow.

Once the cluster tool has been set up with a desired set of chambers and auxiliary equipment for performing certain process steps, the cluster tool will typically process a large number of substrates by continuously passing them, one by one, through a series of chambers or process steps. The process recipes and sequences will typically be programmed into a microprocessor controller that will direct, control and monitor the processing of each substrate through the cluster tool. Once an entire cassette of wafers has been successfully processed through the cluster tool, the cassette may be passed to yet another cluster tool or stand alone tool, such as a chemical mechanical polisher, for further processing.

One example of a fabrication system is the cluster tool disclosed in U.S. Pat. No. 6,222,337 (Kroeker et al.), and reproduced in FIGS. 1 and 2 herein. The magnetically coupled robot disclosed therein comprises a frog-leg type connection or arms between the magnetic clamps and the wafer blade to provide both radial and rotational movement of the robot blade within a fixed plane. Radial and rotational movements can be coordinated or combined in order to pickup, transfer and deliver substrates from one location within the cluster tool to another, such as from one chamber to an adjacent chamber.

FIG. 1 is a schematic diagram of the integrated cluster tool 10 of Kroeker et al. Substrates are introduced into and withdrawn from the cluster tool 10 through a cassette loadlock 12. A robot 14 having a blade 17 is located within the cluster tool 10 to transfer the substrates from one process chamber to another, for example cassette loadlock 12, degas wafer orientation chamber 20, preclean chamber 24, PVD TiN chamber 22 and cooldown chamber 26. The robot blade 17 is illustrated in the retracted position for rotating freely within the chamber 18.

A second robot 28 is located in transfer chamber 30 to transfer substrates between various chambers, such as the cooldown chamber 26, preclean chamber 24, CVD A1 chamber (not shown) and a PVD A1Cu processing chamber (not shown). The specific configuration of the chambers illustrated in FIG. 1 comprises an integrated processing system capable of both CVD and PVD processes in a single cluster tool. A microprocessor controller 29 is provided to control the fabricating process sequence, conditions within the cluster tool, and the operation of the robots 14, 28.

FIG. 2 is a schematic view of the magnetically coupled robot of FIG. 1 shown in both the retracted and extended positions. The robot 14 (see FIG. 1) includes a first strut 81 rigidly attached to a first magnet clamp 80 and a second strut 82 rigidly attached to a second magnet clamp 80′. A third strut 83 is attached by a pivot 84 to strut 81 and by a pivot 85 to a wafer blade 86. A fourth strut 87 is attached by a pivot 88 to strut 82 and by a pivot 89 to wafer blade 86. The structure of struts 81-83, 87 and pivots 84, 85, 88, and 89 form a “frog leg” type connection of wafer blade 86 to magnet clamps 80,80′.

When magnet clamps 80,80′ rotate in the same direction with the same angular velocity, then the robot also rotates about axis x in this same direction with the same velocity. When magnet clamps 80, 80′ rotate in opposite directions with the same absolute angular velocity, then there is no rotation of assembly 14, but instead there is linear radial movement of wafer blade 86 to a position illustrated by dashed elements 81′-89′.

A wafer 35 is shown being loaded on wafer blade 86 to illustrate that the wafer blade can be extended through a wafer transfer slot 810 in a wall 811 of a chamber 32 to transfer such a wafer into or out of the chamber 32. The mode in which both motors rotate in the same direction at the same speed can be used to rotate the robot from a position suitable for wafer exchange with one of the adjacent chambers 12, 20, 22, 24, 26 (see FIG. 1) to a position suitable for wafer exchange with another of these chambers. The mode in which both motors rotate with the same speed in opposite directions is then used to extend the wafer blade into one of these chambers and then extract it from that chamber. Some other combination of motor rotation can be used to extend or retract the wafer blade as the robot is being rotated about axis x.

To keep wafer blade 86 directed radially away from the rotation axes x, an interlocking mechanism is used between the pivots or cams 85, 89 to assure an equal and opposite angular rotation of each pivot. The interlocking mechanism may take on many designs. One possible interlocking mechanism is a pair of intermeshed gears 92 and 93 formed on the pivots 85 and 89. These gears are loosely meshed to minimize particulate generation by these gears. To eliminate play between these two gears because of this loose mesh, a weak spring 94 (see FIG. 4) may be extended between a point 95 on one gear to a point 96 on the other gear such that the spring tension lightly rotates these two gears in opposite directions until light contact between these gears is produced.

Although robots of the type depicted in U.S. Pat. No. 6,222,337 (Kroeker et al.) have some desirable properties, robots of this type also have some shortcomings. In particular, it has been found that robots of this type often suffer excessive wear in the hub assembly 14 and in the wrist 85′, 89′ and elbow 84′, 88′ joints, and exhibit deviations from parallelism between the opposing arms. These problems result in excessive maintenance requirements and in deviations in the manufacturing process. There is thus a need in the art for a robotic assembly which overcomes these infirmities, and for a method for making the same. These and other needs are met by the devices and methodologies disclosed herein and hereinafter described.

### SUMMARY OF THE INVENTION

In one aspect, a robotic hub assembly is provided which comprises first and second spacers disposed in opposing relation to each other, and a device, such as a plurality of pins, for restricting the relative motion of the first and second spacers in a lateral direction. The device preferably comprises first and second sets of pins which extend through the first and second spacers. Preferably, the first set of pins extend through holes in the first spacer and rotatingly engage threaded apertures provided in said second spacer, and the second set of pins extend through holes in said second spacer and rotatingly engage threaded apertures provided in said first spacer.

One skilled in the art will appreciate that the various aspects of the present disclosure may be used in various combinations and sub-combinations, and each of those combinations and sub-combinations is to be treated as if specifically set forth herein.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is an illustration of a cluster tool equipped with a robotic wafer handling system;

FIG. 2 is an illustration of the arm assembly of the robot depicted in FIG. 1, and illustrates the retracted and extended positions of the arm assembly;

FIG. 3 is an illustration of the wrist assembly of the robot depicted in FIG. 1;

FIG. 4 is an illustration of a prior art robotic arm assembly and illustrates the retracted and extended positions of the arm assembly;

FIG. 5 is a side view, partially in section, of a spacer configuration made in accordance with the teachings herein; and

FIG. 6 is a side view of the spacer configuration of FIG. 5.

### DETAILED DESCRIPTION OF THE INVENTION

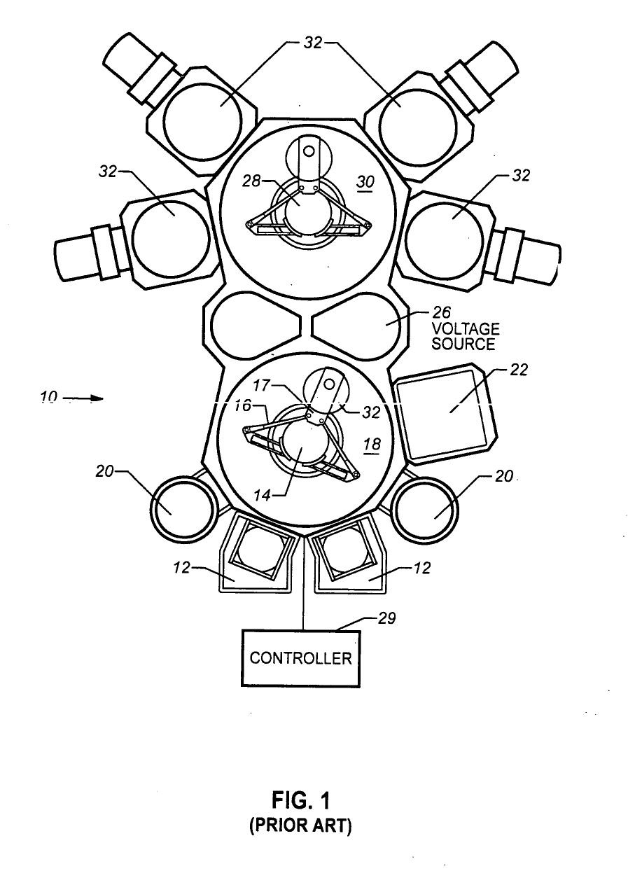

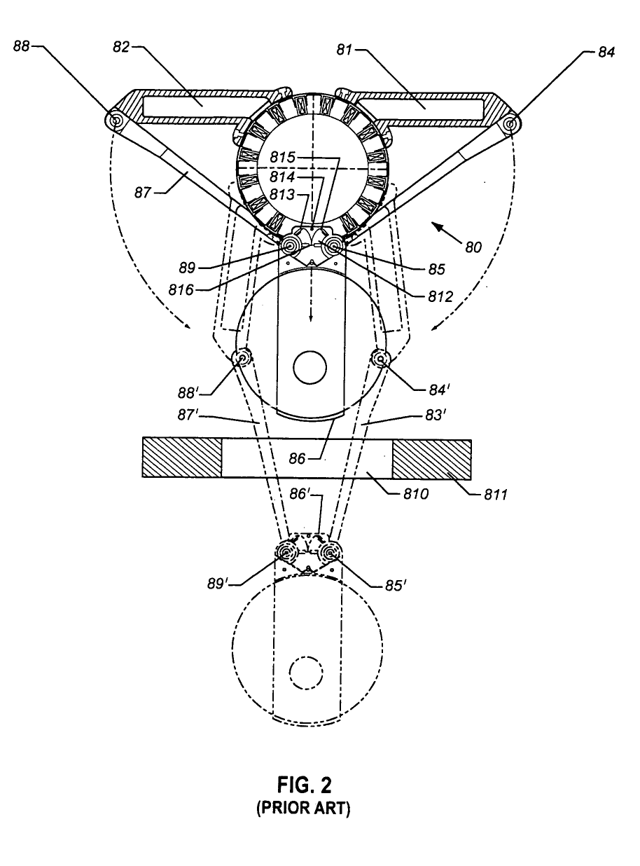

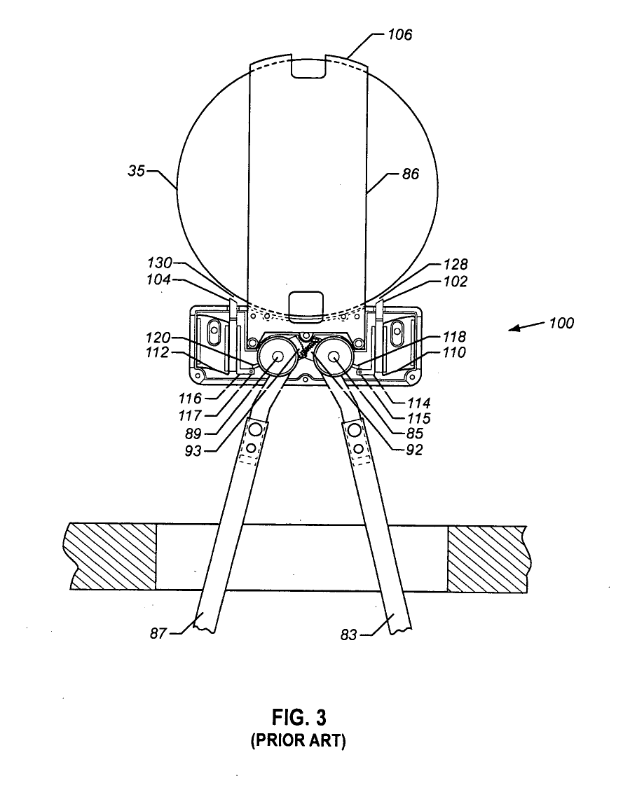

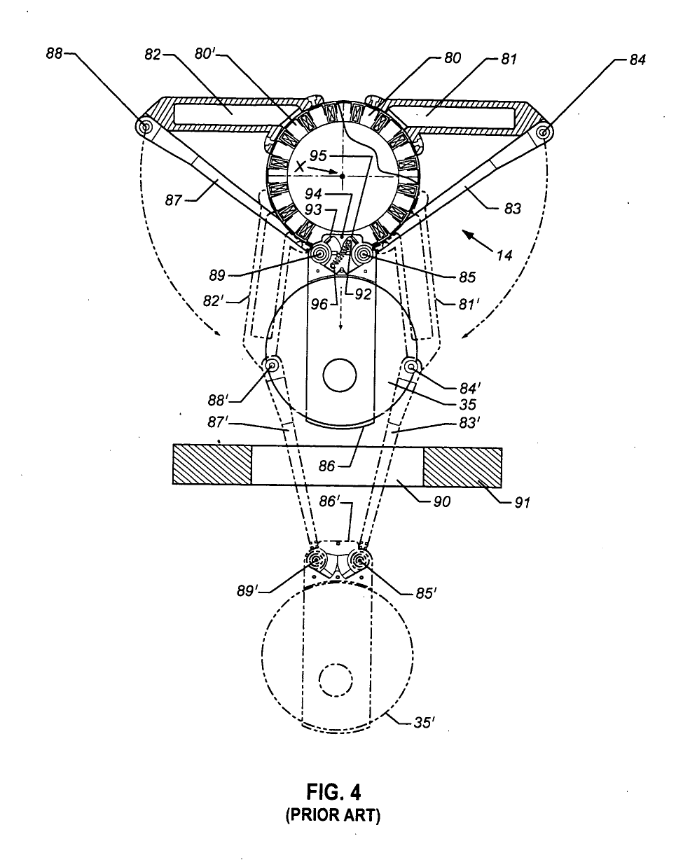

The aforementioned needs are met by the devices and methodologies disclosed herein. In particular, after careful investigation, it has now been found that, in conventional robotic arms of the type illustrated in FIGS. 1-4, the hub assembly can undergo nutation (that is, it can move out of concentricity with its piece parts) and force the lower arm to roll away from the rotating hub axis. For example, in such a configuration, the hub contains two halves, each of which is attached to one of the arms, and these halves are separated by opposing spacers. In use, these spacers can deviate from concentricity, thus causing the aforementioned roll.

In a frog-leg construction such as that depicted in FIGS. 1-4, this roll is transferred along the beam of the lower arm such that the arm is now out of parallelism with the second half of the frog arm. This condition induces stress within the wrist, elbow and hub assemblies, causing premature wear and adding abnormal motions in the z-direction (the direction perpendicular to the plane in which the arms extend and retract) as the arm is in motion. The devices and methodologies disclosed herein provide a means for eliminating this roll, thus preventing such premature wear and allowing the robotic arm to operate properly.

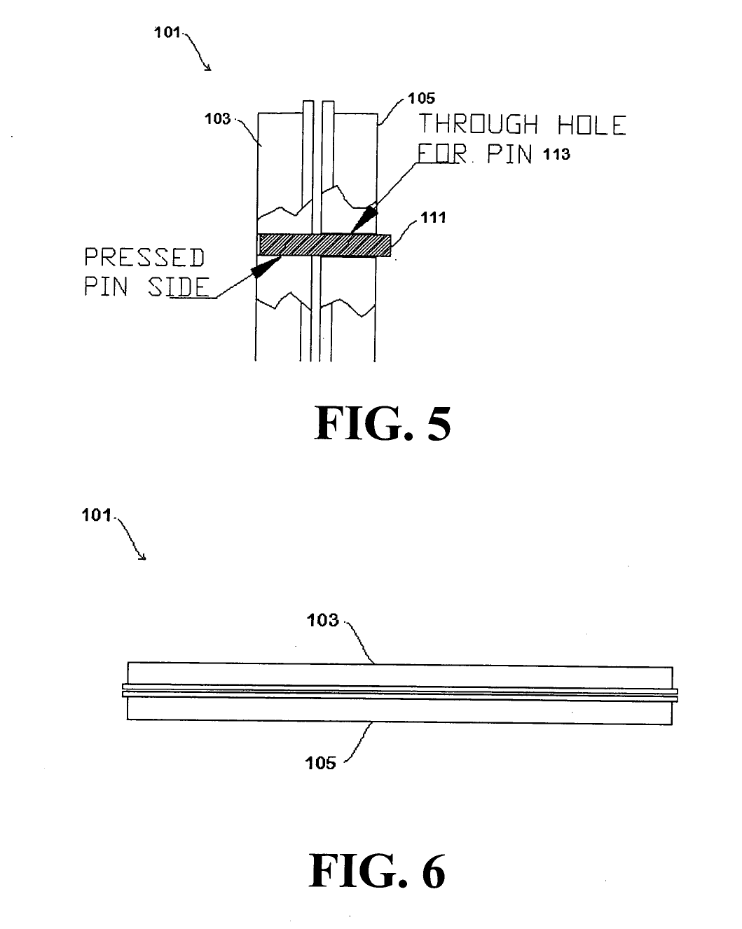

FIGS. 5 and 6 illustrate one non-limiting embodiment of a spacer configuration 101 for a robotic hub made in accordance with the teachings herein. Some of the details of the spacer configuration have been eliminated for simplicity of illustration. The spacer configuration shown therein comprises first 103 and second 105 opposing spacers which are spaced apart from each other by a predetermined distance.

In a completed hub assembly, the first 103 and second 105 spacers are disposed between first and second bearing rings (not shown), and one arm of the robot is attached to each bearing ring. The spacers 103, 105 maintain the first and second bearing rings (not shown) in a proper orientation with respect to each other. The first and second bearing rings rotate in the same direction when the robotic arms (not shown) are to be moved in a lateral direction, and rotate in opposing directions when the robotic arms are to be extended or retracted.

As noted above, in hub assemblies of the prior art which contain spacer configurations somewhat similar in design to the configuration depicted in FIGS. 5 and 6, the two spacers often deviate from concentricity. This frequently happens, for example, when the two bearing rings rotate in opposite directions, and the resulting force pulls the spacers away from concentricity. This causes the hub to undergo nutation, which places stress on the bearings inside the hub and causes premature wear.

The spacer configuration 101 depicted in FIGS. 5 and 6 is adapted to eliminate such nutation by stiffening the hub assembly. This configuration 101 utilizes a series of pins 111 to stiffen the spacer configuration, thereby eliminating lateral motion and maintaining the first 103 and second 105 spacers in a concentric relation to each other.

The through holes 113 for the pins in the spacers are constructed such that the pins can move in a vertical direction, but are restricted in their motion in the lateral direction. In one particular embodiment, for example, the pins are 18/8 hardened steel pins, and the through holes are designed to permit motion of less than about 0.001 inches in the lateral direction.

The pins may be disposed in various manners throughout the spacers. Preferably, however, four pins are utilized, with the pins being spaced 90° apart. It is also preferred that the pins are arranged in pairs such that the pairs are facing opposing directions, and such that each of the pins in the pair are disposed on opposite sides of a spacer.

Although the present invention is described in detail, it should be understood that various changes, substitutions and alterations can be made hereto without departing from the spirit and scope of the invention.

What is claimed is:

1. A robotic hub assembly, comprising:
first and second spacers disposed in opposing relation to each other; and
a device for restricting the relative motion of the first and second spacers in a lateral direction.

2. The robotic hub assembly of claim 1, wherein said device is a plurality of pins.

3. The robotic hub assembly of claim 1, wherein said plurality of pins comprises first and second sets of pins which extend through said first and second spacers.

4. The robotic hub assembly of claim 3, wherein said first set of pins extend through holes in said first spacer and rotatingly engage threaded apertures provided in said second spacer.

5. The robotic hub assembly of claim 4, wherein said second set of pins extend through holes in said second spacer and rotatingly engage threaded apertures provided in said first spacer.
